(19) United States
(12) Patent Application Publication
(10) Pub. No.: US 2008/0174103 A1
(43) Pub. Date: Jul. 24, 2008

(54) Weatherproof, printable form having attached key label

(76) Inventor: Ray J. Basha, Davie, FL (US)

Correspondence Address: SEYFARTH SHAW LLP, 131 S. DEARBORN ST., SUITE 2400, CHICAGO, IL, 60603-5803, US

(21) Appl. No.: 11/654,934

(22) Filed: Jan. 18, 2007

(51) Int. Cl. B42D 15/00; B42D 15/10

(52) U.S. Cl. 283/81; 283/70

(57) ABSTRACT

A label for marketing of goods, particularly for identifying vehicles by attachment thereto, specifically to a vehicle window. The label may comprise at least one printable sheet having at least one removable and typically punch-out key label portion. The key label portion has an elongated attachment portion and a perforation that is proportioned to receive the elongated attachment portion through the perforation, for attachment of the key label portion to a key after it has been removed from the label. The printable sheet may be made of flexible plastic material that is stronger than a cellulose paper sheet of corresponding thickness when wet with water. The label also may be of multiple layers.

### BACKGROUND OF THE INVENTION

In the business of selling new and used vehicles such as cars, trucks, SUVs, RVS, motorcycles, boats, aircraft, and the like, any visitor to a sales lot will note that the vehicles typically have a label attached to a vehicle window, describing the various characteristics of the vehicle, such as type, options present, and list price. Typically, these labels are paper labels, and thus are attached to the inside of the window, for protection from the elements. They may be computer printed, each with the specific details of the vehicle to which they are attached.

By this invention, a typically weatherproof label is provided which may, if desired, be attached to the outside of the window, but alternatively may be placed on the inside, if desired. The label may be computer printed, and, additionally, a feature is provided by which keys of the vehicle, or keys of another large item to which the label is applied, may have an attached identifying label, which can be printed along with the label of this invention, and then removed as desired for attachment to a key, keys, or any other object, for proper identification thereof.

### DESCRIPTION OF THE INVENTION

By this invention, a label is provided for the marketing of goods, particularly vehicles that carry a separate key, and other items, especially those that might use a key, such as lockable computers or other instruments. The label is attachable to the vehicle or other goods, and typically comprises at least one printable sheet having at least one punch-out or otherwise removable key label portion. The key label portion has an elongated attachment portion, and a perforation that is proportioned to receive the elongated attachment portion passing through it, for attachment of the key label portion to a key, after removal from the whole label.

Thus, the label can be applied to the goods, such as a window of the vehicle, and a key for the vehicle may be separately identified by attachment of the punch-out or otherwise removable key label portion, which may be taken off of the label, and which may be printed with identifying data at the same time that the label is printed. The key label portion may be punched out by separating a surrounding line of tearing weakness, or it may alternatively be removably adhered as a separate layer to the rest of the label, and peeled off. The punch-out key label portion has the advantage of being printable on both sides.

Typically, a computer is used to print the specific, pertinent information relating to the vehicle or other goods being marketed. Examples of information that might be placed on the label by a computer would be the year, make, model, and color of the vehicle, along with the various options present, and the like The actual vehicle color may be printed on either or both of the label itself and each punch-out key label portion, as desired. The application of the actual color of the vehicle to the label carried on the key assists a holder of the key in finding the vehicle, for example in a large sales lot or the like.

In some embodiments, the at least one printable sheet, or all sheets present if desired, may comprise a laser-printable or ink jet-printable, flexible plastic material that is stronger, when wet with water, than a cellulose paper sheet of corresponding thickness, when wet with water. Other forms of printing may also be used, the form selected being typically one that is particularly compatible with the computer system used for individualized printing on the label. Thus, such a flexible plastic material that is stronger, when wet with water, than a wetted cellulose paper sheet is substantially more weather resistant than cellulose paper, and is thus capable of application on the outside of a vehicle window, if desired. Waterproof ink of course will be used in that circumstance.

Examples of such flexible plastic material include Teslin® SPID synthetic printing sheet for laser printing, sold by PPG Industries, Inc. of Pittsburg, Pa. 15272. This material is a coated, porous, highly filled polyolefin film.

Another material that may be used for the printable sheet comprises Proprint III of Transilwrap Company, Inc. of Strongsville, Ohio 44149. Other printable sheeting made of polyester or the like may also be used.

In some embodiments, at least a pair of the flexible plastic, printable sheets are present, a first sheet and a second sheet, bonded together by an adhesive layer which is intended to be permanently bonded on one of the sheets and releasably bonded to at least part of the other sheet. One or both sides of this multiple-ply label may carry identifying indicia for the goods.

In some embodiments, the adhesive layer covers most but not all of the first, printable sheet. Particularly, the section which defines the punch-out key label portion is typically free of adhesive.

In the circumstance where the pair of sheets are bonded together by the adhesive, the first sheet may be longer than the second sheet bonded to it, to define a projecting portion spaced from the second sheet, which projecting portion defines the punch-out key portion or portions. The second sheet may be substantially completely coated and bonded by the adhesive over its entire surface.

Also, in some preferred embodiments, a peripheral portion of the second sheet is defined outside of a line of tearing weakness. The peripheral portion can be like a frame around the remainder of the second sheet, although not necessarily providing a frame to all four rectangular sides of the sheet. This line of tearing weakness permits removal of the peripheral portion by tearing off of the line of tearing weakness to expose at least some of the adhesive layer underneath the peripheral portion. This permits securance of the label to a surface, which may be either the inside surface or the outside surface of a vehicle window. Depending upon the nature of use, either the first sheet or the second sheet, or both, may be the sheet that is computer printed. As stated, such a label may be placed either on the inside or the outside of the window, with the side of the multiple layer label that is appropriate being printed. As stated, both sides of the label may be computer printed, if desired.

In some embodiments, the adhesive layer is continuous from side edge to side edge of the multiple layer label comprising the first and second sheets, so that, upon removal of the peripheral, frame portion of the second sheet, there still are portions of the adhesive layer present to hold the remaining portion of the second sheet and the first sheet together.

In some embodiments, the second sheet may be made of cellulose or other paper, while the first sheet is made of a flexible plastic material as described above, or both of the sheets may be made of the flexible plastic material described.

Additionally, some embodiments of the label of this invention may not contain the punch-out key label portion, but may simply comprise bonded sheets as described above, at least one sheet typically but not necessarily comprising the flexible plastic material that is stronger than a cellulose paper sheet of corresponding thickness when wet with water.

Thus, a label is provided which may be computer printed with the exact, individual data of the particular goods, typically a vehicle to which it is to be attached. When desired, a punch-out key label portion or portions may be provided, for identification of separable keys that are associated with the vehicle or other goods, and these label portions may be printed with pertinent data along with the rest of the form. The form may be printed on either side or both sides, and may comprise a pair of bonded sheets in which the second of the sheets has peel away portions, which may be easily removed by tearing along a line of tearing weakness to expose portions of an adhesive layer positioned between the first and second sheets, for attachment of the label to a vehicle or the like. The peel away portions may be peripheral as described above, but they also may comprise spot portions spaced from the edges of the label, or similarly spaced strip portions, and the like.

Thus, the label is very easily used in a variety of systems for identifying vehicles and the like, and may be weatherproof, for attachment to an outside vehicle window, or to a wall of typically large capital goods, for identification and description thereof.

### DESCRIPTION OF THE DRAWINGS

In the drawings, FIG. 1 is a plan view of a multiple ply label for marketing of goods, specifically a window sticker for a new or used vehicle which is for sale at a dealer.

FIG. 2 is a perspective view of the label of FIG. 1, with a portion of the second sheet separated.

FIG. 3 is a plan view of the label of FIG. 1 after detachment of the projecting portion that contains punch-out key label portions.

FIG. 4 is a fragmentary, perspective view showing the printed label attached to the window of a vehicle such as an automobile.

FIG. 5 is a perspective view showing how a punch-out key portion, carrying printed information, can be attached to a key for the vehicle shown in FIG. 4.

FIG. 6 is a plan view of a label for a motorcycle.

FIG. 7 is a perspective view of the label of FIG. 6 showing punched-out portions.

### DESCRIPTION OF SPECIFIC EMBODIMENTS

Referring to the drawings, FIGS. 1-3 show a label for the marketing of goods, particularly for attachment to the window of an automobile or other vehicle. As can be seen, this attachment can be either on the inside or the outside of the vehicle.

Label 10 comprises a first, flexible plastic, printable sheet 12, which carries a layer 14 of adhesive, typically across the entire width of first sheet 12 at positions above and below tear line 16, formed in first sheet 12. Tear line 16 extends across the width of first sheet 12.

A second sheet 18 is connected to first sheet 12 by adhesive layer 14. Typically, adhesive layer 14 is intended to be permanently bonded to sheet 12, and releasably bonded to second sheet 18. This may be accomplished by providing a suitable plastic coating or the like to sheet 18, or by other proper selection of materials. Sheet 18 thus, in part, serves as a removable backing for adhesive 14, but sheet 18 may also serve other functions as described below. Typically, the entire area of sheet 18 is bonded with adhesive of adhesive layer 14.

First sheet 12 also defines a projecting portion 20 extending beyond second sheet 18, which, in turn, defines a pair of punch-out key label portions 22, each being peripherally attached to projecting portion 20 by an appropriate perforation line 24, comprising mostly spaces and having some narrow bridges of frangible, connecting material to hold key label portions 22 in place. For example, the nature of the particular perforation used may be a 20 point hold perforation, as described in the industry, or any other appropriate perforation arrangement so that key label portions 22 may be punched out and removed from aperture 25, in the manner of key label portion 22a in FIG. 3.

First sheet 12 is longer than second sheet 18, to define projecting portion 20, which defines the punch-out key portions 22.

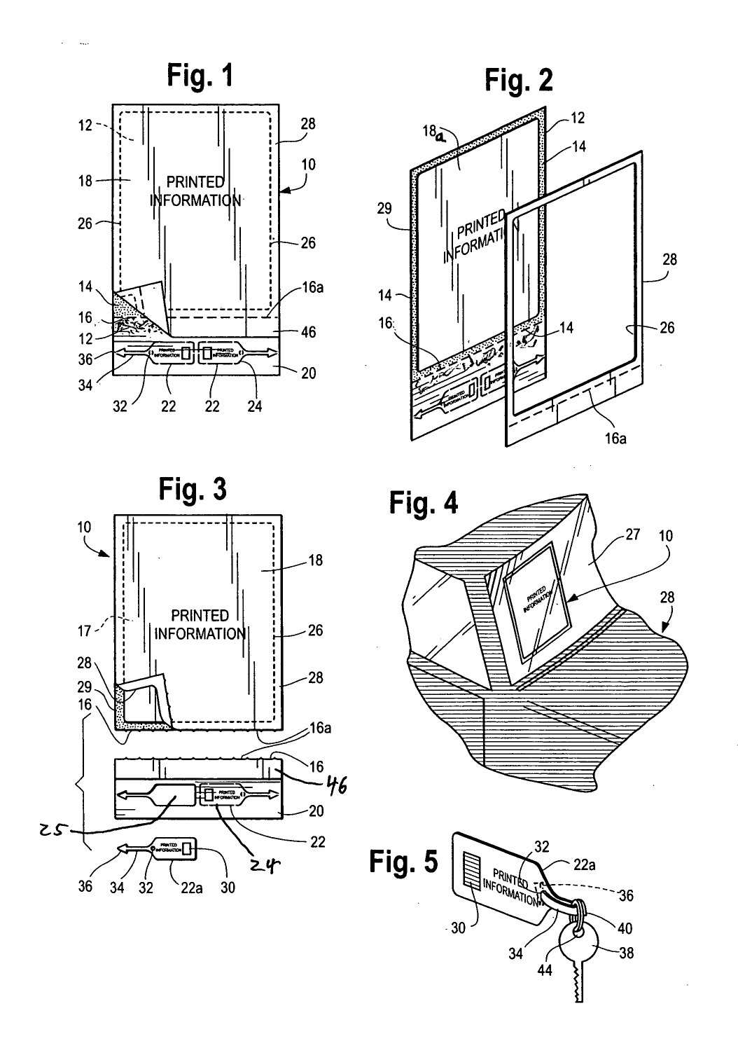

A second completely cut line or line of tearing weakness 26, generally rectangular in shape, is formed only in second sheet 18 to define an outer frame portion 28 which, when removed, exposes an outer portion 29 of adhesive layer 14 as shown in FIG. 2. Central portion 18a of the second sheet remains attached to first sheet 12, being retained by the remainder of adhesive layer 14 extending across sheet 12. Second sheet central portion 18a reduces the exposed adhesive area of layer 14, for easier removal of label 10 from surface, and central portion 18a can also be all or part of the printed label portion, if desired.

In the embodiment shown, both first sheet 12 and second sheet 18 are made of a plastic material, for example the Teslin® SPID synthetic printing sheet for laser printing as described above. This material is stronger than a cellulose paper sheet of corresponding thickness when wet with water, so that multiple ply label 10 may be placed on the outside of a window of a vehicle 28, as shown in FIG. 4. Alternatively, it may be placed on the inside of the vehicle as well, being adhered there by the rectangular, outer, exposed band 29 of adhesive, which may be exposed when frame portion 28 is removed along cut line 26, to expose it, as can be seen in FIG. 3.

The perforations used for lines 16, 16a may, if desired, be about a 70 point microperforation, for having very fine holes, which is suitable for the particular, flexible plastic, printable sheet described above.

Perforated tear line 16 in first sheet 12, and a corresponding, perforated tear line 16a in second sheet 18 may, in some embodiments, be in precisely the same position, being even formed by the same perforating wheel in the manufacturing process. As stated before, these perforated lines 16, 16a are within the area of adhesive layer 14, since, typically, the adhesive layer 14 extends throughout the entire area of second sheet 18, although the area of the adhesive layer 14 is less than the total area of first sheet 12, since first sheet 12 has projecting portion 20 which contains punch-out key label portions 22. Thus, second sheet 18 may be bonded across its entire area to first sheet 12.

Thus, the respective perforations 16, 16a may be reliably torn without damage to the portion of label 10 which remains after removal of bonded sheet portion 20, originally part of first sheet 12, and bonded sheet portion 46, which was originally part of second sheet 18, before tearing of perforations 16, 16a (FIG. 3). Portion 46, upon separation from sheet 18, remains bonded to portion 20 by the adhesive between the two portions. The slightly thickened pair of layers 20, 46 gives the user a good grip for simultaneously tearing the two perforated lines 16, 16a, for separation of the lower portion including key label portions 22, 22a as shown in FIG. 3.

As an alternate embodiment, first sheet 12 may be of a more flexible material such as a polyvinylchloride formulation, bonded to a stiffer material that comprises portion 20, which portion defines the punch-out key label portions in the manner shown, so that first sheet 12 comprises two separate types of material, bonded together at a junction.

In use, the manufactured multiple ply label 10 may be provided to the user in completely blank form, although preprinting of a portion of the planned, printed format may be provided as desired, such as a logo and other headings which would be used on all forms. However, one may start with a fully blank form, which may be printed on either or both sides, as desired.

Specifically, the blank, assembled, multiple ply labels 10 may be printed on one or both sides with a color laser printer or the like, in which all desired printing is applied. The generally permanent, unchanging forms of printing found on a multiplicity of forms in the particular business using the forms may be printed, as well as the individualized data provided by the computer, and for example including the year, make, model, and color of the vehicle, all in one printing step for each side, or with a single printing step for both sides. A sample of the actual color of vehicle 28 to which the individual, printed form applies may be provided by the computer printer as well on the first and/or second sheets. Also, the punch-out key label portions 22 may be printed at the same time, on both sides if desired, and containing on one or both sides, if desired, a sample 30 of the actual color of vehicle 28 to which the individual form applies.

Each key label 22, 22a has a perforation such as a small hole 32, and an elongated attachment portion 34, ending in an enlarged, typically arrow-spaced head portion 36 as shown in FIG. 5. Punched out key label portion 22a, after label 10 has been printed, may be attached to a key 38, optionally by attachment to a conventional wire ring 40. Elongated attachment portion 34 may then be looped around, and penetrating end portion 36 may pass through perforation 32 and, by the nature of the arrow shape of the end portion 36, be retained there forming a retaining loop, as can be seen in FIG. 5. Attachment portion 34 passes through a conventional wire ring 40, thus connecting punched-out key label portion 22a with key 38. If desired, elongated attachment portion 34 may be looped through the hole 44 of key 38, for attachment without the use of a wire ring 40.

The printed label 10, as stated, may have printed information on one or both sides, as may the punch-out key label portions 22, 22a.

After printing, the tear lines 16, 16a may be torn to remove projecting portion 20 from first sheet 12 along tear line 16, and to also remove an optional end portion 46 from second sheet 18 by tearing of tear line 16a. The various tear lines 16, 16a, and die cut line 26 may be conventionally cut into the respective sheets 12, 18 during the manufacturing process. Line 26 may be a fully cut line, formed only in sheet 18.

Thus, after printing of one or both sides of label 10 and optionally after separating portions 20, 46, frame 28 may be removed by peeling away from label 10 along second line of tearing weakness 26, as shown in FIG. 3, to expose peripheral, adhesive layer 29. Label 10 may then be applied to vehicle window 27, either on the inside or the outside thereof, as desired. Because of the use of the desired, stronger, flexible plastic material, label 10 can be durable on the outside of window 27. Since there is choice of side or sides to be printed on label 10, suitable instructions for the specific printing may be easily sent to the computer-printer system, depending on whether it is desired to place label 10 on the inside or outside of window 27. This may be done by the dealer, or anybody else who is involved.

Thus, label 10 starts out blank, and may be converted by printing, typically with a color laser printer, into labels or “stickers” of various types used for example in the automobile retail industry. For example, label 10 may thus comprise a typical window sticker for a vehicle, or a “certified sticker”, or a buyer's guide, each being produced from the same blank label 10 by appropriate instructions provided to the computer/printer system. Thus, individual dealers have great flexibility in their printing operation, since they can start with the blank labels 10, and convert them by printing into any desired format.

Thus, a weatherproof label is provided, having great flexibility of use for providing the desired and necessary marketing information to all who are concerned. Optionally, the label may carry punch-out key label portions 22 which may also be printed with desired identification information, optionally including barcode, as the rest of the blank label is printed, and which may, if desired, carry a sample of the color of vehicle to which the key label portion relates. This punch-out key label portion 22 may then be attached to a key 38 for identification thereof and association with the vehicle referred to in the individual label 10 after printing.

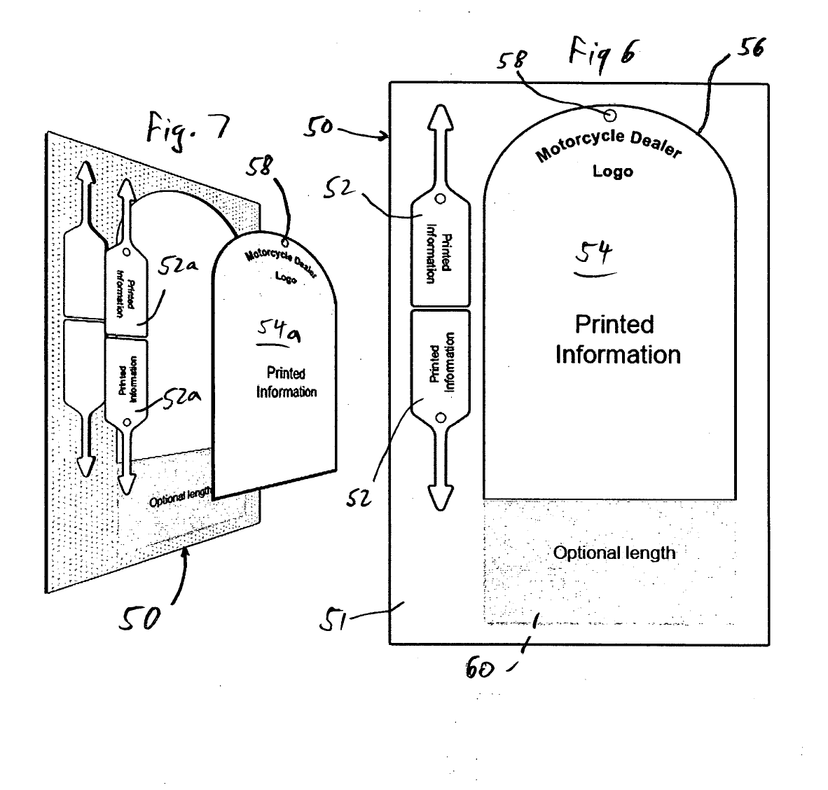

Referring to FIGS. 6 and 7, another, weatherproof label 50 is disclosed, specifically for use with a motorcycle or other vehicle or large item, particularly an item that requires an identification key label 52 which is separable from the original label 50.

The label 50, in the embodiment shown, comprises a single, printable sheet 51 made of a non-cellulose plastic material as described above which is stronger, when wet, then a wet cellulose paper sheet of corresponding thickness. It may be printed on both sides in the manner previously described, being provided, if desired, to the dealer or other user of the label in a stack of labels or the like for individualized printing with a computer located at the dealer. If desired, the entire printing on one or both sides of the label sheet is accomplished in a single step, as described above, so that the label is individualized for attachment to the particular item that it describes.

Particularly, label 50 not only has punch-out key label portions 52, which may be identical to the key label portions 22 of the previous embodiment, but a label portion 54 may also be formed by a closed loop perforation line 56 in the original sheet 51 as shown, so that label portion 54 may also be punched out from sheet 51 in a manner similar to the punch out key portions 52. All of these punched-out portions 52, 54 are shown in punched-out condition in FIG. 7 as members 52a, 54a.

In this embodiment, adhesive may not be used, but, rather, label portion 54 may be attached to a string or wire which is threaded through a hole 58, to be hung on the device that is to be identified, for example, a motorcycle by being hung on the handlebars thereof.

This label may also be used with appliances and the like, with the key label portions 52, 52a carrying information so that a consumer can punch them out for reference, and carry them away from the item being identified: for example, a television set, an appliance, or the like, to assist the consumer in making a selection among a large variety of appliances, television sets or other electronic equipment. In this circumstance, label 50 might have many equivalent punch-out portions like key label portions 52, but not for purpose of attaching to a key, but merely for consumer reference as they wander around a store. However, as shown, key label portions 52 are used for attachment to a key to the motorcycle or other vehicle to which label 54 pertains, in a manner similar to key label portion 22.

Portion 60 represents an optional length of label 54, showing that the size of label portion 54 in label 50 can vary as may be desired. The label portion 54 of the desired size is surrounded by perforated line 56, so that it may be manually removed from the larger label 50 after printing has taken place.

The above has been offered for illustrative purposes only, and is not intended to limit the scope of the invention of this application, which is as described in the claims below.

That which is claimed is:

1. A label for marketing of goods, said label being attachable to the goods, said label comprising at least one printable sheet having at least one removable key label portion, said removable key label portion having an elongated attachment portion and a perforation that is proportioned to receive said elongated attachment portion, for attachment of the key label portion to a key after removal from the label.

2. The label of claim 1 in which said printable sheet comprises flexible plastic material that is stronger than a cellulose paper sheet of corresponding thickness when wet with water.

3. The label of claim 2 in which a first said flexible plastic, printable sheet is present, carrying an adhesive layer, and a second sheet connected to said first sheet by said adhesive layer, one of said sheets being permanently bonded to the adhesive layer and at least part of the other of said sheets being releasably bonded to the adhesive layer, at least one of said sheets and the key label portion carrying identifying indicia for the goods.

4. The label of claim 3 in which the label is attached to a vehicle and the key label portion is a punch-out key label portion.

5. The label of claim 4 in which the key label portion carries a sample of the vehicle color.

6. The label of claim 3 in which said adhesive layer covers most but not all of the first printable sheet.

7. The label of claim 3 in which the first sheet is longer than the second sheet bonded to it, to define a projecting portion spaced from the second sheet, said projecting portion defining said removable key label portion.

8. The label of claim 3 in which a peripheral portion of said second sheet is defined outside of a cut line or line of tearing weakness formed in said second sheet, said cut line or line of tearing weakness permitting removal of said peripheral portion of the second sheet, to expose at least some of said adhesive layer on the first sheet, to permit securance of said label to a surface.

9. The label of claim 3 in which both said first and second sheets are made of said plastic material.

10. The label of claim 9 in which a peripheral portion of said second sheet is defined outside of a cut line or line of tearing weakness formed in said second sheet, said cut line or line of tearing weakness permitting removal of said peripheral portion of said second sheet, to expose at least some of said adhesive layer on the first sheet, to permit securance of said label to a surface.

11. The label of claim 10 in which said one sheet is longer than the second sheet bonded to it, to define a projecting portion spaced from the second sheet, said projecting portion defining a punch-out key label portion.

12. The label of claim 11 in which said adhesive layer covers most but not all the first printable sheet.

13. A label for marketing of goods, said label being attachable to the goods, said label comprising a first, flexible plastic, printable sheet that is stronger than a cellulose paper sheet of corresponding thickness when wet with water, said first sheet carrying an adhesive layer, and a second sheet connected to said first sheet by said adhesive layer, one of said sheets being permanently bonded to the adhesive layer and at least part of the other of said sheets being releasably bonded to the adhesive layer.

14. The label of claim 13, which is attached to a vehicle, and which carries printed identifying indicia for the goods.

15. The label of claim 14 which carries a sample of the vehicle color.

16. The label of claim 14 in which a peripheral portion of said second sheet is defined outside of a cut line or line of tearing weakness formed in said second sheet, said cut line or line of tearing weakness permitting removal of said peripheral portion of said second sheet, to expose at least some of said adhesive layer on the first sheet, to permit securance of said label to a surface.

17. The label of claim 16 in which both said first and second sheets are made of said plastic material and which comprises at least one removable label portion.

18. The method of preparing a label for attachment to goods for marketing of said goods, which comprises providing at least one printable sheet that is without printing and which has an adhesive layer, and a second sheet connected to said printable sheet by the adhesive layer, said sheets being bonded to the adhesive layer; a peripheral portion of one of said sheets being defined outside of a line of tearing weakness formed in said sheet, to permit removal of said peripheral portion of said sheet by tearing of said line of tearing weakness, to expose at least some of said adhesive layer, to permit securance of said label to a surface; passing said bonded sheets through a computer operated printer and applying by said printer in a single step for at least each side printed, all printing intended to be added to the label prior to attachment to the goods.

19. The method of claim 18 in which said at least one printable sheet has at least one punch-out key label portion, said punch-out key label portion having an elongated attachment portion and a perforation that is proportioned to receive said elongated attachment portion, for attachment of the key label portion to a key after removal from the label, said key label portion being printed with desired data during said single printing step.

20. The method of claim 19 in which said printable sheet comprises flexible plastic material that is stronger than a cellulose paper sheet of corresponding thickness when wet with water.

21. The method of claim 20, including the further step of attaching said label to a vehicle by adhering at least some of said adhesive layer to the vehicle.

22. The method of claim 21 in which a sample of the vehicle color is applied by printing in said printing step to said key label portion.

23. The method of claim 22 in which said color is applied on both sides of said key label portion.

24. The method of claim 18 in which printing is applied in a single step to both sides of said label.
